(19) United States
(12) Patent Application Publication
(10) Pub. No.: US 2024/0319935 A1
(43) Pub. Date: Sep. 26, 2024

(54) CONTROL METHOD, NON-TRANSITORY COMPUTER-READABLE STORAGE MEDIUM STORING PROGRAM, AND SYSTEM

(71) Applicant: CANON KABUSHIKI KAISHA, Tokyo (JP)

(72) Inventor: KIYOHIRO TSUNEKAWA, Kanagawa (JP)

(21) Appl. No.: 18/603,369

(22) Filed: Mar. 13, 2024

(30) Foreign Application Priority Data
Mar. 24, 2023 (JP) 2023-048615

(51) Int. Cl. G06F 3/12; H04W 76/18

(52) U.S. Cl. CPC G06F 3/1236; G06F 3/1203; G06F 3/121; G06F 3/1286; G06F 3/1292; H04W 76/18

(57) ABSTRACT

An information processing apparatus performs processing including: acquiring device information of a communication apparatus from the communication apparatus; executing setup processing for connecting the communication apparatus to an external apparatus outside the communication apparatus and the information processing apparatus; and displaying, on a display unit, a guidance for executing the setup processing based on the acquired device information of the communication apparatus. The guidance is made different between a case where the device information of the communication apparatus indicates that the communication apparatus includes a predetermined component and a case where the device information indicates that the communication apparatus does not include the predetermined component.

### BACKGROUND OF THE INVENTION

### Field of the Invention

The present invention relates to a control method, a non-transitory computer-readable storage medium storing a program, and a system.

### Description of the Related Art

There is known a method using a PC and a portable terminal (to be referred to as a terminal apparatus hereinafter) as a connection setting method of connecting a communication apparatus (to be also referred to as a printing apparatus hereinafter) including a wireless interface, such as a printer or a multi-function peripheral, to an access point (to be referred to as an AP hereinafter) of a wireless network. Japanese Patent Laid-Open No. 2022-81165 describes an electronic device that starts a setup procedure of a first method based on an operation of a specific button and attempts to perform connection to an AP of a wireless network using connection information acquired from an external device. The connection information is transmitted to a printing apparatus based on a user operation of an application operating on a terminal apparatus after the printing apparatus and the terminal apparatus are temporarily, wirelessly connected by the WFD method.

### SUMMARY OF THE INVENTION

It is necessary to further improve convenience in a setup of connecting a communication apparatus to an external AP.

The present invention provides an information processing apparatus for improving convenience in a setup of a communication apparatus, a method, a non-transitory computer-readable storage medium storing a program, and a system.

The present invention in one aspect provides a control method executed by an information processing apparatus, comprising: acquiring device information of a communication apparatus from the communication apparatus; executing setup processing for connecting the communication apparatus to an external apparatus outside the communication apparatus and the information processing apparatus; and displaying, on a display unit, a guidance for executing the setup processing based on the acquired device information of the communication apparatus, wherein the guidance is made different between a case where the device information of the communication apparatus indicates that the communication apparatus includes a predetermined component and a case where the device information indicates that the communication apparatus does not include the predetermined component.

According to the present invention, it is possible to improve convenience in a setup of a communication apparatus.

Further features of the present invention will become apparent from the following description of exemplary embodiments with reference to the attached drawings.

### BRIEF DESCRIPTION OF THE DRAWINGS

FIGS. 1A and 1B are views each showing the network configuration of a communication system;

FIG. 2 is a block diagram showing the hardware arrangement of a printing apparatus and a terminal apparatus;

FIGS. 3A and 3B are block diagrams respectively showing the software arrangements of the printing apparatus and the terminal apparatus;

FIGS. 4A and 4B are views each showing the outer appearance of an operation unit of the printing apparatus;

FIG. 5 is a flowchart illustrating processing executed in the printing apparatus at the time of arrival;

FIG. 6 is a flowchart illustrating initial installation processing of the printing apparatus;

FIGS. 7A and 7B are flowcharts illustrating network setup processing of the printing apparatus;

FIG. 8 is a flowchart illustrating processing executed in the terminal apparatus;

FIG. 9 is a flowchart illustrating processing executed in the terminal apparatus;

FIG. 10 is a flowchart illustrating processing executed in the terminal apparatus;

FIGS. 11A to 11F are views each showing a user interface screen;

FIG. 12 is a view showing a MIB definition reflecting the arrangement information of the operation unit;

FIGS. 13A and 13B are views each showing a user interface screen;

FIG. 14 is a flowchart illustrating processing executed in a terminal apparatus; and

FIG. 15 is a view showing a user interface screen.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

First, a communication apparatus and a terminal apparatus included in a communication system according to this embodiment will be described. In this embodiment, as an example, an arrangement in which a portable terminal as a terminal apparatus (information processing apparatus) and a printing apparatus as a communication apparatus, such as a printer or a multi-function peripheral, are connected to a wireless network created by an access point (AP) will be described. However, the present invention is not limited to this. For example, as the terminal apparatus, various kinds of apparatuses such as a Personal Computer (PC), a tablet terminal, a Personal Digital Assistant (PDA), and a digital camera are applicable. In this embodiment, a printer is exemplified as the communication apparatus but the present invention is not limited to this, and various kinds of apparatuses are applicable as long as they can wirelessly communicate with the information processing apparatus. For example, concerning a printer, an inkjet printer, a full-color laser beam printer, a monochrome printer, and the like are applicable. Furthermore, not only a printer but also a copying machine, a facsimile apparatus, a terminal apparatus, a smartphone, a notebook PC, a tablet terminal, a PDA, a digital camera, a music reproduction device, a television, a smart speaker, and the like are applicable. In addition, a multi-function peripheral having a plurality of functions such as a copying function, a FAX function, and a print function is applicable. As the printing apparatus of this embodiment, a printer using cut paper will be described as an example but a printer having another arrangement may be used. For example, a printer using roll paper may be used. In this embodiment, initial installation includes, for example, print preparation processing such as a setup (ink setup) of an ink cartridge, detection of a paper setting operation, registration processing (registration adjustment) as processing for adjusting the landing position of ink on a sheet in printing, and connection setting to an external apparatus.

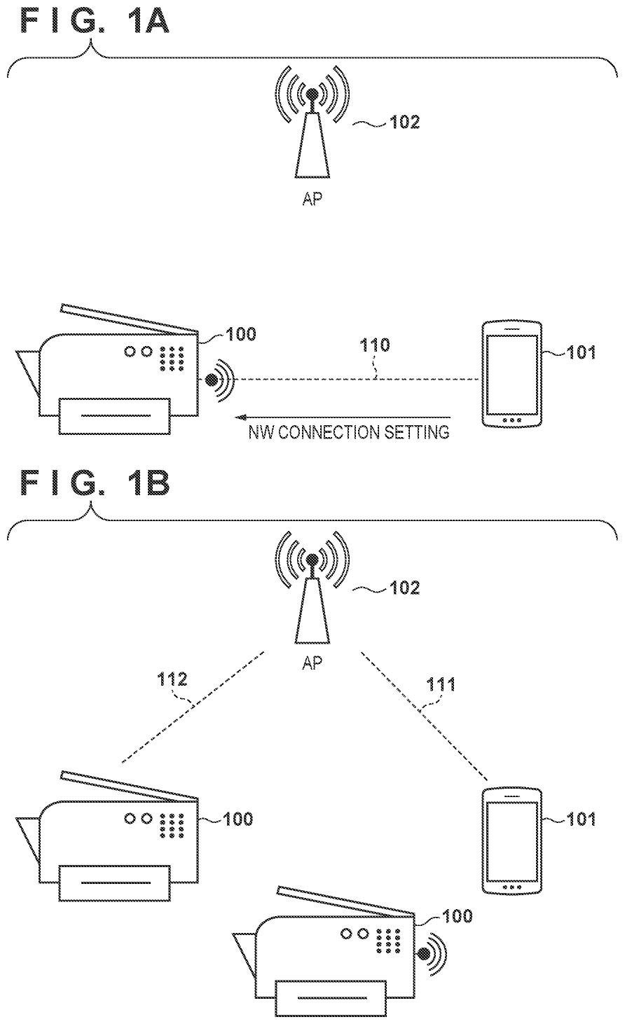

FIGS. 1A and 1B are views each showing an example of the network configuration of a communication system according to this embodiment. In this embodiment, for example, an information processing apparatus serves as a terminal apparatus 101 and a communication apparatus serves as a printing apparatus 100. FIG. 1A shows an arrangement when the printing apparatus (printer) 100 receives, from the terminal apparatus 101, connection information (wireless profile) necessary for connection to an AP 102 and executes connection setting, that is, a network setup.

Referring to FIG. 1A, the printing apparatus 100 activates a network setup mode of operating as a network setup access point (master station) under a predetermined condition, and waits for connection from the terminal apparatus 101 (slave station) and input of connection information to the AP 102. The SSID of the setup access point includes a predetermined character string recognizable by the setting application of the terminal apparatus 101. Therefore, the setting application can search for the printing apparatus 100 in the network setup mode. The setting application will be described later.

Note that a form in which the printing apparatus 100 directly communicates with another apparatus such as the terminal apparatus 101 without intervention of the AP 102 forming a wireless network will be referred to as point-to-point (P2P) connection or direct connection 110 hereinafter. Note that an apparatus such as a wireless LAN router can be used as the AP 102 but the present invention is not limited to the wireless LAN router and a relay or the like may be used as long as the printing apparatus 100 and the terminal apparatus 101 can wirelessly be connected by a predetermined communication protocol.

Note that in this embodiment, the predetermined condition is always satisfied at the time of initial installation of the printing apparatus 100, and is also satisfied when a wireless connection button (to be described later) provided in the operation unit of the printing apparatus 100 is pressed. That is, at the time of initial installation or the pressing of the wireless connection button, the printing apparatus 100 operates as a network setup access point.

FIG. 1B shows the configuration in a case where the printing apparatus 100 is successfully connected to a wireless network 112 of the AP 102 using connection information to the AP 102, which has been received from the terminal apparatus 101 in the network setup mode. If the terminal apparatus 101 stores in advance the connection information (wireless profile) to the AP 102, wireless connection 111 to the AP 102 is established under the control of the OS of the terminal apparatus 101 and the setting application after the end of a network setup. Then, it is possible to, for example, input a print job to the printing apparatus 100 by wireless communication from the terminal apparatus 101 via the AP 102.

Note that a method of connecting the printing apparatus 100 to the terminal apparatus 101 via the AP 102 as an external apparatus is called an infrastructure connection method. In connection by the infrastructure connection method, the AP 102 operates as a master station and the printing apparatus 100 and the terminal apparatus 101 operate as slave stations.

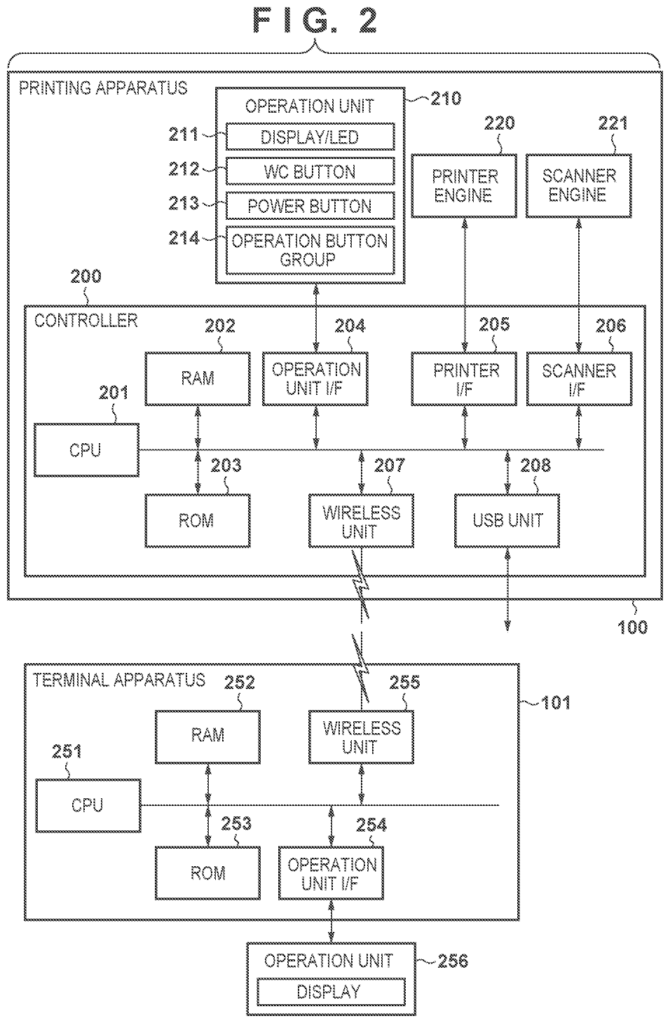

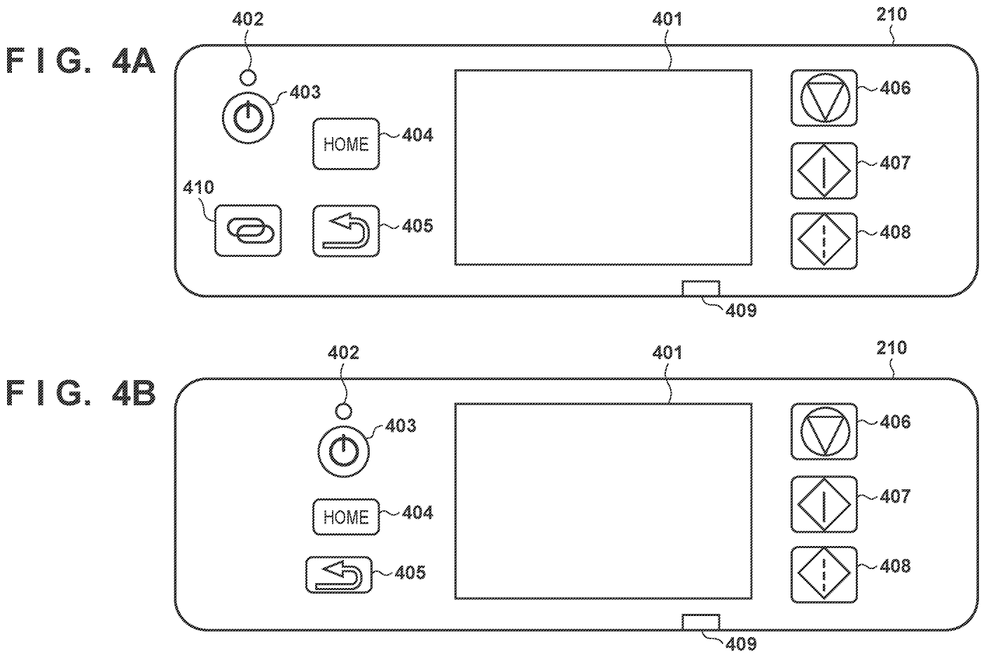

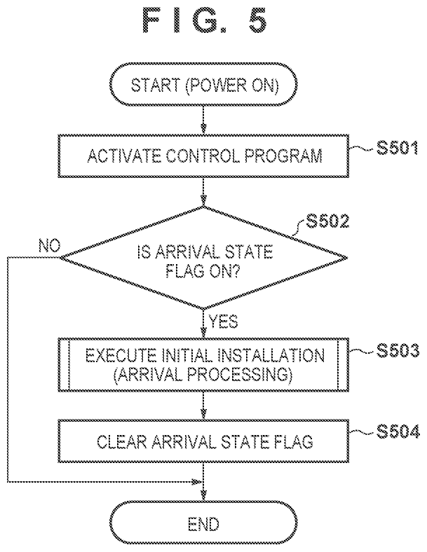

In this embodiment, assume that there exist a printing apparatus having a WC button (to be described later) and a printing apparatus having no WC button as the printing apparatus 100. The printing apparatus 100 shown in FIG. 1A is a printing apparatus having a WC button. The printing apparatus 100 located on the upper side in FIG. 1B is a printing apparatus having a WC button. The printing apparatus 100 located on the lower side in FIG. 1B is a printing apparatus having no WC button. The printing apparatus 100 having a WC button will sometimes be referred to as a printing apparatus 100a hereinafter, and the printing apparatus 100 having no WC button will sometimes be referred to as a printing apparatus 100b hereinafter. The printing apparatus 100a and the printing apparatus 100b will sometime collectively be referred to as the printing apparatuses 100 if these are not particularly discriminated. FIG. 1B shows a state in which the printing apparatus 100b operates in the network setup mode. The printing apparatus 100b can also perform a network setup using the terminal apparatus 101, similar to the printing apparatus 100a. However, in the printing apparatus 100b, the arrangement of the operation unit is different from that in the printing apparatus 100a, as will be described later with reference to FIGS. 2 and 4.

Subsequently, the hardware arrangement of the printing apparatus 100 and the terminal apparatus 101 according to this embodiment will be described with reference to a block diagram shown in FIG. 2. Furthermore, in this embodiment, the following arrangement will be exemplified. However, this embodiment is applicable to an apparatus that can wirelessly communicate with an external apparatus, and is not limited to the arrangement shown in FIG. 2. Note that the printing apparatus 100b shown in FIG. 1B also has the same hardware arrangement as that of the printing apparatus 100a except for some components of the operation unit to be described later with reference to FIGS. 2 and 4.

The printing apparatus 100 includes at least a control unit (controller) 200 that controls the overall apparatus, an operation unit 210, and a printer engine 220. In a case where the printing apparatus 100 is formed as a Multifunctional Peripheral (MFP), the printing apparatus 100 further includes a scanner engine 221. In the control unit 200, a CPU 201, a RAM 202, a ROM 203, an operation unit I/F 204, a printer I/F 205, a wireless unit 207, and a USB unit 208 are connected to each other via a communication bus, and the control unit 200 functions as a computer that controls the overall printing apparatus 100. Note that in a case where the printing apparatus 100 is formed as an MFP, the control unit 200 further includes a scanner I/F 206.

The CPU 201 is a processor that reads out control programs stored in the ROM 203 and executes them, and implements, by the control programs, processing shown in a flowchart to be described later. As a result of executing the control programs, various functions such as communication control with an external apparatus such as the terminal apparatus 101 and generation of image data corresponding to an input print job are implemented.

The RAM 202 is formed by a DRAM, an SRAM, or the like, which needs a backup power supply, and is used as a memory area that stores temporary setting information, management data, and the like when the printing apparatus 100 operates. Furthermore, the RAM 202 is used as a main memory and a temporary memory area such as a work area of the CPU 201, and is used as a reception buffer or the like for temporarily saving a print job received from the terminal apparatus 101 or the like.

The ROM 203 is a nonvolatile flash memory that stores permanent data such as control programs to be executed by the CPU 201, various data tables, and an OS program. In this embodiment, the control programs stored in the ROM 203 perform software execution control such as scheduling, task switch, and interrupt processing under the management of the embedded OS stored in the ROM 203. The ROM 203 further stores rewritable program control variables and counter information such as the number of print sheets. Some of the program control variables are configured to be rewritable by an instruction from an external apparatus or a menu displayed on the operation unit 210.

In this embodiment, the ROM 203 stores information representing whether the power-on of the printing apparatus 100 is first power-on (power-on at the time of arrival) after shipment from the factory. The operation unit I/F 204 connects the operation unit 210 and the control unit 200. In addition to a power button 213, the operation unit 210 according to this embodiment includes a physical operation button group 214 for controlling various functions such as a copy function of the printing apparatus 100, and a wireless connection button (WC button) 212 for starting the network setup mode.

A display 211 is a display unit formed by including an LCD panel and a light emitting diode, and displays various menus and makes a notification of status information of the printing apparatus 100. Note that the display 211 may be configured to function as an operation panel that displays a software keyboard, software buttons, a menu, and the like, and accepts an operation instruction from the user. Therefore, FIG. 2 shows the display 211 as part of the operation unit 210.

The operation unit I/F 204 accepts data input and an operation instruction from the user by detecting the pressing of the physical button by the user and the operation/input of the menu displayed on the display 211, and notifying the control unit 200 of instruction contents represented by the operation/input as a signal. Note that in this embodiment, the printing apparatus 100b shown in FIG. 1B has no WC button 212. An embodiment in which the WC button 212 is provided as a software button displayed on the display 211 will be described later.

The printer I/F 205 connects the printer engine 220 and the control unit 200. The printer engine 220 forms an image on a print medium such as cut paper by discharging a print material such as ink onto the print medium based on image data input via the printer I/F 205, thereby outputting a print result. Furthermore, the printer engine 220 is configured to perform, as initial installation processing, cleaning of a printhead (to be described later) and registration adjustment for adjusting the discharge position of the ink in a case where the power-on is determined to be at the time of arrival.

The scanner engine 221 reads image data or document data from a sheet set on an original table (not shown) based on input from the operation unit 210 or a scan job received from the terminal apparatus 101 or the like. The read data is saved in the RAM 202 or transmitted to the terminal apparatus 101 or the like as a scan result. If the printing apparatus 100 is a Single Function Printer (SFP), it need not include the scanner engine 221.

The wireless unit 207 is a unit that controls wireless communication with an external apparatus such as the terminal apparatus 101, and is formed by, for example, an LSI. In this embodiment, the wireless unit 207 controls data transmission/reception complying with a communication standard defined by IEEE 802.11 in accordance with an instruction from the CPU 201. A wireless communication method used at this time is, for example, a method defined as Wireless Fidelity (Wi-Fi®) by Wi-Fi Alliance, and is defined as a wireless LAN standard.

The mode and connection method for executing wireless communication using the wireless unit 207 will be described below.

### Direct Connection Method

Direct connection indicates a form in which apparatuses are wirelessly connected directly (that is, by Peer to Peer) without intervention of an external apparatus such as the AP 102. Direct connection is also called Peer to Peer connection (P2P connection). As one connection mode, the printing apparatus 100 can operate in a mode (direct connection mode) for communication by direct connection. In Wi-Fi communication, the mode for communication by direct connection includes a plurality of modes such as a software AP mode and a Wi-Fi Direct (WFD) mode.

A mode in which direct connection is executed by WFD is called a WFD mode. WFD is a standard developed by Wi-Fi Alliance and is a standard included in the IEEE 802.11 communication standards. In the WFD mode, a device serving as a communication partner is searched for by a device search command, then the roles of a P2P group owner (GO) and P2P client are decided, and remaining wireless connection processing is performed. The group owner corresponds to a Wi-Fi master station (master unit), and the client corresponds to a Wi-Fi slave station (slave unit). This role making corresponds to, for example, Go Negotiation in P2P. Note that in the WFD mode in a state before role making is performed, the printing apparatus 100 is neither the master station nor the slave station. More specifically, first, one of devices to communicate with each other issues a device search command and searches for a device to be connected in the WFD mode. After the other device serving as a communication partner is found, the devices confirm information about services and functions that can be supplied by the respective devices. Note that the device supply information confirmation is an option and is dispensable. The device supply information confirmation phase corresponds to, for example, P2P Provision Discovery. Then, the devices confirm the device supply information and decide, as roles, which device serves as a P2P client and which device serves as a P2P group owner. After the client and the group owner are decided, the devices exchange parameters for performing WFD communication. Based on the exchanged parameters, the P2P client and the P2P group owner perform remaining wireless communication processing and IP connection processing. Note that in the WFD mode, the printing apparatus 100 may always operate as the GO without executing the above-described GO Negotiation. That is, the printing apparatus 100 may operate in the WFD mode that is an Autonomous GO mode. The state in which the printing apparatus 100 operates in the WFD mode is, for example, a state in which WFD connection is not established but the printing apparatus 100 operates as the GO, or a state in which WFD connection is established and the printing apparatus 100 operates as the GO.

In the software AP mode, one device (for example, the terminal apparatus 101) among devices (for example, the terminal apparatus 101 and the printing apparatus 100) to communicate with each other serves as a client that plays a role of requesting various services. The other device implements the function of an access point in Wi-Fi by software setting. The software AP corresponds to a Wi-Fi master station, and the client corresponds to a Wi-Fi slave station. In the software AP mode, the client searches for a device serving as a software AP by a device search command. After the software AP is found, the client and the software AP perform remaining wireless connection processing (establishment of wireless connection and the like) and IP connection processing (assignment of an IP address and the like). Note that commands and parameters transmitted/received when implementing wireless connection between the client and the software AP suffice to be those defined by the Wi-Fi standard, and a description thereof will be omitted here.

In this embodiment, in a case where the printing apparatus 100 establishes and maintains direct connection, it operates as a master station in a network to which the printing apparatus 100 belongs. Note that the master station is an apparatus that creates a wireless network, and is an apparatus that provides a slave station with parameters used in connection to the wireless network. The parameters used in connection to the wireless network are, for example, parameters about a channel used by the master station. The slave station receives the parameters and is then connected to the wireless network created by the master station using the channel used by the master station. In the direct connection mode, the printing apparatus 100 operates as the master station and can thus decide a specific frequency band and channel to be used for communication in the direct connection mode. In this embodiment, the printing apparatus 100 can use a channel corresponding to the 2.4-GHz frequency band and a channel corresponding to the 5-GHz frequency band for communication in the direct connection mode.

### Infrastructure Connection Method

Infrastructure connection is a connection form in which devices (for example, the terminal apparatus 101 and the printing apparatus 100) to communicate with each other are connected to an access point (for example, the AP 102) that controls a network of the devices, and the devices communicate with each other via the access point. As one connection mode, the printing apparatus 100 can operate in a mode (infrastructure connection mode) for communication by infrastructure connection.

In infrastructure connection, each device searches for an access point by a device search command. After an access point is found, the device and the access point perform remaining wireless connection processing (establishment of wireless connection and the like) and then IP connection processing (assignment of an IP address and the like). Note that commands and parameters transmitted/received when implementing wireless connection between the device and the access point suffice to be those defined by the Wi-Fi standard, and a description thereof will be omitted here.

In this embodiment, when the printing apparatus 100 operates in infrastructure connection, the AP 102 operates as a master station and the printing apparatus 100 operates as a slave unit. That is, in this embodiment, infrastructure connection means connection between the printing apparatus 100 operating as a slave unit and the apparatus operating as a master unit. In a case where the printing apparatus 100 establishes infrastructure connection and the terminal apparatus 101 also establishes infrastructure connection to the AP 102, the printing apparatus 100 and the terminal apparatus 101 can communicate with each other via the AP 102. Since the AP 102 decides a channel to be used for communication in infrastructure connection, the printing apparatus 100 executes communication in infrastructure connection using the channel decided by the AP 102. In this embodiment, the printing apparatus 100 can use a channel corresponding to the 2.4-GHz frequency band and a channel corresponding to the 5-GHz frequency band for communication in infrastructure connection. Note that the printing apparatus 100 can also use a channel corresponding to the DFS band in the 5-GHz frequency band for communication in infrastructure connection. Note also that to communicate with the printing apparatus 100 via the AP 102, the terminal apparatus 101 needs to recognize that the printing apparatus 100 belongs to a network which is formed by the AP 102 and to which the terminal apparatus 101 belongs.

### Network Setup Mode

The printing apparatus 100 can operate in the network setup mode. A trigger for the printing apparatus 100 to start an operation in the network setup mode may be, for example, the pressing of a network setup mode button by the user or activation (power-on) of the printing apparatus 100 for the first time after arrival. The network setup mode button may be a hardware (physical) button of the printing apparatus 100 or a software button displayed on the display 211 by the printing apparatus 100. In this embodiment, assume that the WC button is the network setup mode button, and is a hardware button of the printing apparatus 100.

When the printing apparatus 100 starts an operation in the network setup mode, it enables Wi-Fi communication. More specifically, as Wi-Fi communication enabling processing, the printing apparatus 100 enables an internal AP (connection setting AP) of the printing apparatus 100 that is dedicated to the network setup mode. Then, the printing apparatus 100 can establish Wi-Fi direct connection to the terminal apparatus 101. Assume that connection information (SSID and password) for connection to the connection setting AP is held in advance in a setup application installed in the terminal apparatus 101, and the terminal apparatus 101 recognizes in advance the connection information for connection to the connection setting AP. Therefore, unlike connection information of an AP enabled in the direct connection mode, the connection information for connection to the connection setting AP cannot be changed arbitrarily by the user. Note that in the network setup mode, the printing apparatus 100 may be connected to the terminal apparatus 101 by not normal Wi-Fi but Wi-Fi Direct (WFD). That is, the printing apparatus 100 may operate as a group owner, and receive a setting command from the terminal apparatus 101 by WFD communication. Alternatively, the printing apparatus 100 may be connected to the terminal apparatus 101 by Bluetooth in the network setup mode. Bluetooth includes Bluetooth Classic and Bluetooth Low Energy (BLE). That is, for example, the printing apparatus 100 may operate as a slave apparatus in BLE in the network setup mode, and receive a setting command from the terminal apparatus 101 by BLE communication. Furthermore, in the network setup mode, the printing apparatus 100 may be able to execute both a network setup by Wi-Fi and a network setup by BLE. That is, when the printing apparatus 100 starts an operation in the network setup mode, it may enable both Wi-Fi communication and BLE communication. More specifically, when the printing apparatus 100 starts an operation in the network setup mode, it may enable both the connection setting AP and an advertising state in which BLE connection is enabled by transmitting advertising information by BLE.

As described above, the printing apparatus 100 according to this embodiment operates in the network setup mode for executing a network setup of the printing apparatus 100 in accordance with a predetermined condition including the pressing of the WC button 212 by the user and the initial installation timing. When the printing apparatus 100 operates in the network setup mode, it controls the wireless unit 207 to operate as a setup access point that is enabled only during an operation in the network setup mode. The setup access point is an access point different from that enabled in the above-described software AP mode. Assume that the SSID of the setup access point includes a predetermined character string recognizable by the setting application of the terminal apparatus 101.

Assume that the printing apparatus 100 operating in the network setup mode uses a predetermined communication protocol (setup communication protocol) in communication with the terminal apparatus 101 connected to the setup access point. More specifically, the setup communication protocol is, for example, Simple Network Management Protocol (SNMP).

If a predetermined time elapses after the printing apparatus 100 starts an operation in the network setup mode, the printing apparatus 100 stops the operation in the network setup mode and disables the setup access point. Furthermore, even when the connection information for connection to the AP 102 and a change instruction of the wireless communication operation mode are received from the terminal apparatus 101 in the network setup mode, the setup access point is disabled.

The USB unit 208 incorporates an LSI called a USB device controller. The USB device controller is connected to a signal line forming a USB bus, and communicates with an external apparatus complying with the USB communication standard by transmitting/receiving data in accordance with an instruction from the CPU 201 and notifying the CPU 201 of an event occurring on the USB bus.

Upon detecting connection to a communication apparatus such as a PC (not shown) including a USB, the printing apparatus 100 according to this embodiment receives print data and returns various statuses in accordance with instructions from the PC serving as a USB host. Furthermore, the printing apparatus 100 of this embodiment is also configured to perform communication using SNMP on the USB (SNMP over USB), and can perform a network setup via the USB using the setting application operating on the PC. However, in a state in which the printing apparatus 100 is connected to the PC by a USB cable, they can communicate with each other regardless of the wireless communication operation mode, and thus it is unnecessary to perform time-out control unlike a network setup via Wi-Fi.

The terminal apparatus 101 will be described below. In this embodiment, the terminal apparatus 101 will be explained as a portable terminal (smartphone). However, another terminal apparatus such as a PC may be used as long as it can execute a network setup by wireless communication.

The terminal apparatus 101 includes a CPU 251, a RAM 252, a ROM 253, an operation unit I/F 254, a wireless unit 255, and an operation unit 256. The CPU 251 is a processor that reads out control programs stored in the ROM 253 and executes them, and controls the overall terminal apparatus 101 by the control programs while executing processing shown in a flowchart to be described later. As a result of executing the control programs, various functions of the terminal apparatus 101 such as communication control with an external apparatus such as the printing apparatus 100, generation of a print job to be output to the printing apparatus 100, and a network setup instruction are implemented.

The RAM 252 is formed by a DRAM, an SRAM, or the like, which needs a backup power supply, and is used as a memory area that stores temporary setting information, management data, and the like when the terminal apparatus 101 operates. Furthermore, the RAM 252 is used as a main memory and a temporary memory area such as a work area of the CPU 251, and is used as a transmission buffer or the like for temporarily saving a print job generated to be transmitted to the printing apparatus 100 or the like.

The ROM 253 is a nonvolatile flash memory that stores permanent data such as control programs to be executed by the CPU 251, various data tables, and an OS program. In this embodiment, the ROM 253 stores, as some of the control programs, an application program (to be referred to as a setting application hereinafter) for executing a network setup of the printing apparatus 100, a printer driver for generating a print job interpretable by the printing apparatus 100, and the like. The setting application is an application program for performing connection setting to the AP 102 that is the connection destination of the printing apparatus 100, and may have another function in addition to the network setup function. For example, the setting application may have a function of causing the printing apparatus 100 to execute printing, a function of causing the printing apparatus 100 to scan a set document, a function of confirming the state of the printing apparatus 100, and the like. For example, the setting application is stored in the ROM 253 by being installed from an external server by Internet communication via the wireless unit 255. Assume that the setting application is an application provided by the vender of the printing apparatus 100.

By the control programs, the operation unit 256 functions as an operation panel that can display a software keyboard, software buttons, a menu, and the like on the LCD display and accept an operation instruction from the user. Therefore, the operation unit 256 also serves as a display unit. The wireless unit 255 is a unit that controls wireless communication with an external apparatus such as the printing apparatus 100, and is formed by, for example, an LSI. In this embodiment, the wireless unit 255 controls data transmission/reception complying with a communication standard defined by IEEE 802.11 in accordance with an instruction form the CPU 251. In a wireless communication method supported by the wireless unit 255, wireless communication can be performed in the WFD mode of performing direct connection, similar to the printing apparatus 100, and in an ad hoc mode of performing connection without using an AP and the infrastructure connection mode of performing connection via the external AP 102. However, the wireless unit 255 only operates as a slave station.

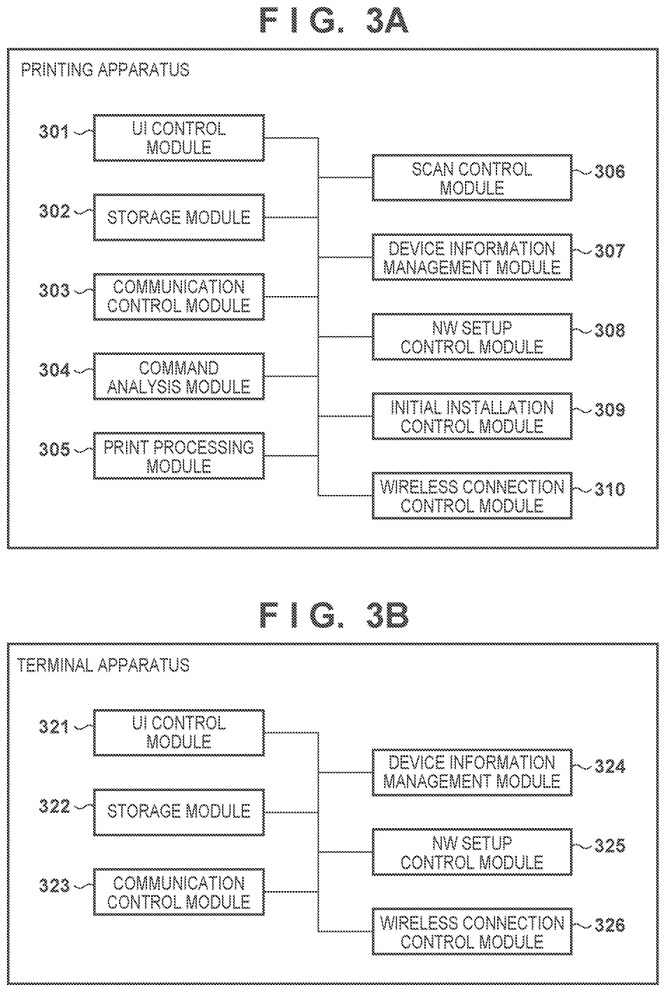

The software arrangements of the printing apparatus 100 and the terminal apparatus 101 according to this embodiment will be described below with reference to FIGS. 3A and 3B. Note that the software arrangement of the printing apparatus 100 shown in FIG. 3A is implemented when the CPU 201 of the printing apparatus 100 reads out the control programs stored in the ROM 203 and executes them. Furthermore, the software arrangement of the terminal apparatus 101 shown in FIG. 3B is implemented when the CPU 251 of the terminal apparatus 101 reads out the control programs stored in the ROM 253 and executes them.

A UI control module 301 of the printing apparatus 100 is a control program concerning control of the operation unit 210 of the printing apparatus 100. The UI control module 301 displays an operation screen such as a menu on the display 211. Furthermore, the UI control module 301 detects an input instruction by a user operation including the pressing of a physical button shown in FIG. 2, and accepts input of various setting values and an execution instruction of various kinds of processes. A storage module 302 is a control program that controls write/read of data such as program control variables in/from a predetermined memory area in the RAM 202 and the ROM 203 in accordance with an instruction from another control unit.

A communication control module 303 is a control program that controls the wireless unit 207 and the USB unit 208 to communicate with an external apparatus in accordance with a predetermined communication protocol, and is divided in accordance with respective communication units (interfaces). With respect to the wireless unit 207, the communication control module 303 controls packet processing complying with a protocol stack such as the TCP/IP or UDP protocol stack. With respect to the USB unit 208, the communication control module 303 controls communication such as bulk transfer or control transfer defined as a USB device class.

A command analysis module 304 analyzes input data received by the communication control module 303. If the input data is a print job, the command analysis module 304 performs analysis in accordance with a predetermined language (for example, Page Description Language (PDL)), and generates corresponding image data. Alternatively, if the input data is a SNMP packet, the command analysis module 304 controls a response of device information managed as a Management Information Base (MIB) by a device information management module 307 and write in a MIB in accordance with an instruction command. As the device information managed as a MIB, private MIB information originally defined by the vendor is managed in addition to standard MIB information such as printer MIB information. In this embodiment, as the private MIB information, information indicating whether it is possible to start the operation mode of the wireless unit 207 or the network setup mode by a user operation during initial installation at the time of arrival is included. In this embodiment, in a case where the WC button 212 is provided as the arrangement information of the operation unit 210, it is determined that it is possible to start the network setup mode by a user operation during initial installation. Note that in this embodiment, information concerning a network setup mode start method is managed as an MIB by the SNMP protocol. However, the present invention is not limited to this.

A print processing module 305 controls the printhead of the printer engine 220 by transmitting, to the printer I/F 205, a signal corresponding to the image data generated by the command analysis module 304, thereby performing print processing on a print medium. In initial installation at the time of arrival (to be described later), the print processing module 305 controls cleaning of the printhead and a registration adjustment operation in accordance with an instruction of an initial installation control module 309. A scan control module 306 controls the scanner engine 221 via the scanner I/F 206.

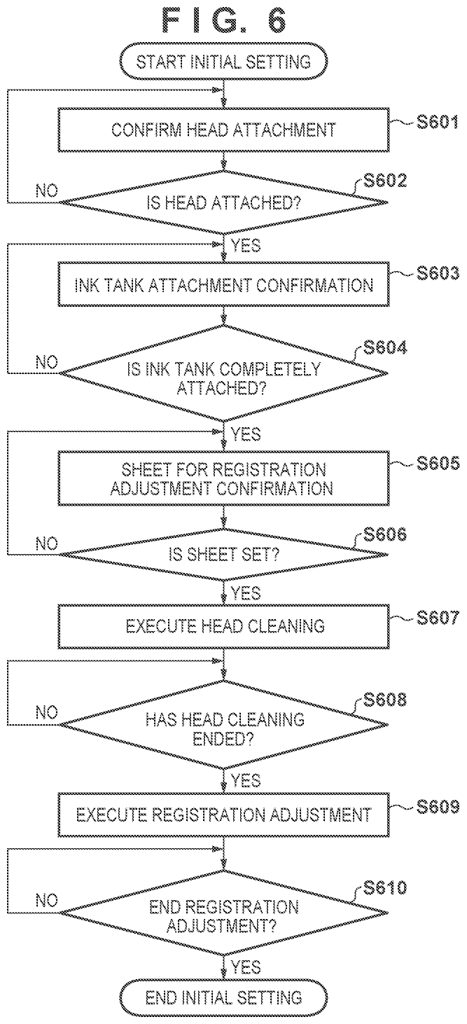

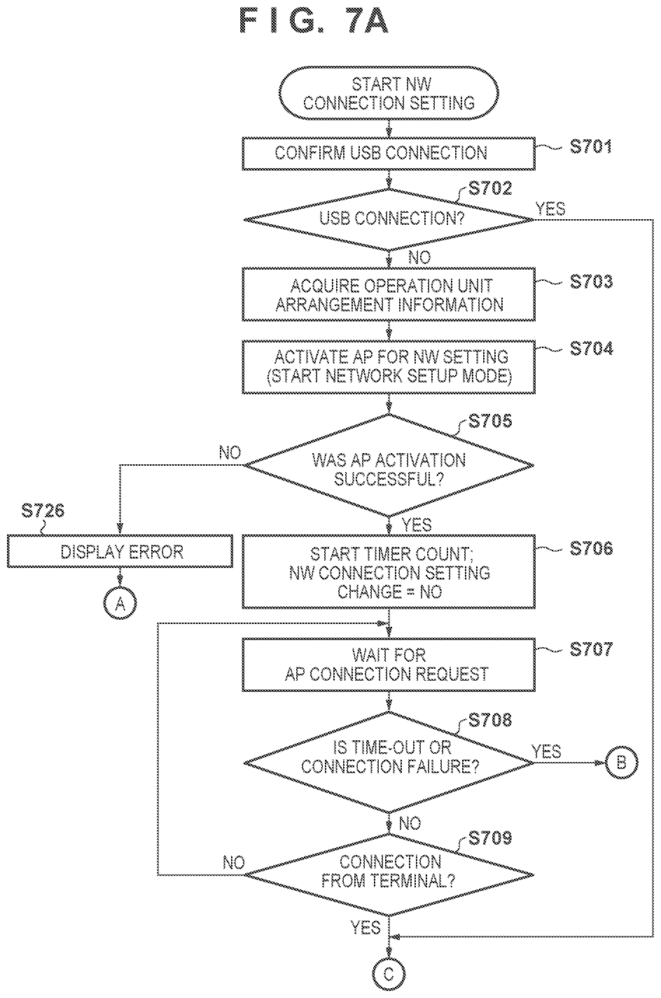

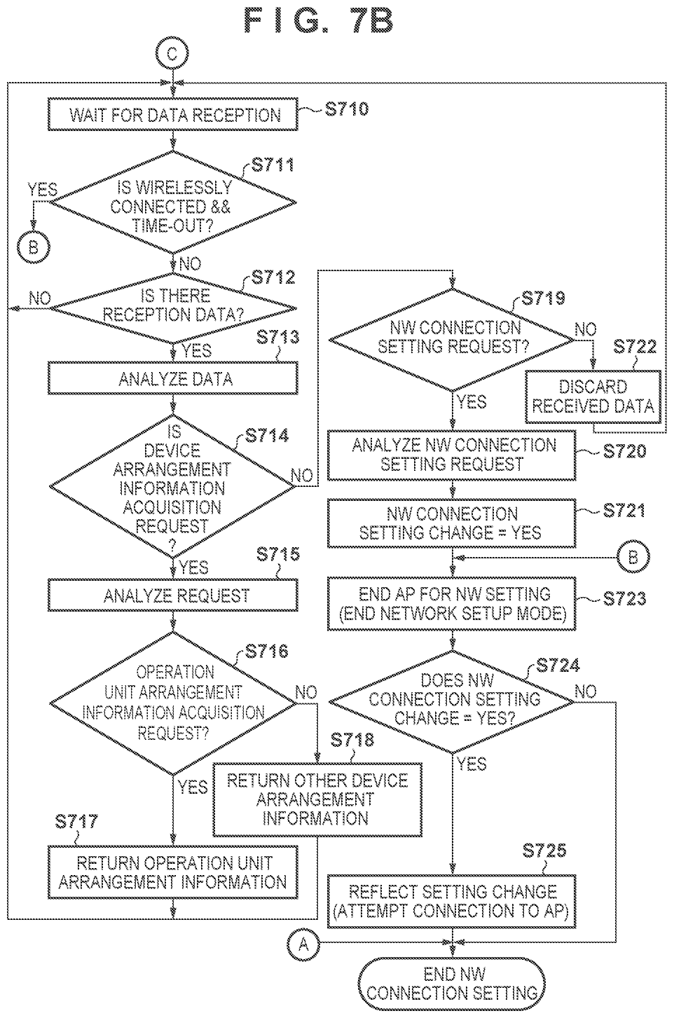

A network (NW) setup control module 308 is a control program that controls an operation in the network setup mode. A detailed control procedure will be described later with reference to a flowchart shown in FIGS. 7A and 7B. The initial installation control module 309 is a control program that controls initial installation at the time of arrival. A detailed control procedure will be described later with reference to a flowchart shown in FIG. 6.

A wireless connection control module 310 controls a series of wireless connection processes of a wireless authentication procedure using an encryption method, such as a search for a wireless beacon generated by the master station (AP 102 or printing apparatus 100), an association procedure with the master station, and Wi-Fi Protected Access (WPA). The printing apparatus 100 according to this embodiment controls both a case where the printing apparatus operates as a slave station to perform a connection operation to the AP 102 and a case where the printing apparatus 100 operates as an AP (master station) to process a connection request from the terminal apparatus 101. Note that the wireless connection control module 310 may control a wireless connection procedure in accordance with Device Provisioning Protocol (DPP) known as Wi-Fi Easy Connect (WEC).

Furthermore, the printing apparatus 100 includes an Operating System (OS) (not shown), and a BIOS and boot loader for activating the OS at the time of power-on in addition to the above-described control programs (modules). The OS provides various kinds of services with respect to the above control programs operating as application software, such as process (task) control, management of resources such as a memory and file system, and detection of a hardware interrupt. For example, Linux®-based kernel is known as an embedded OS but an OS originally prepared by the vendor may be used.

A UI control module 321 of the terminal apparatus 101 is a control program concerning control of the operation unit 256 of the terminal apparatus 101. The UI control module 321 performs general display control on the display and general input control by a user operation.

A storage module 322 is a control program that stores or reads out designated data in or from a predetermined memory area in the RAM 252 and the ROM 253 and the ROM 253 in accordance with an instruction from another control unit. For example, the storage module 322 stores connection information (wireless profile) to the AP 102 and the like in a predetermined area in the ROM 253 in accordance with an instruction of a wireless connection control module 326. A communication control module 323 is a control program that controls the wireless unit 255 to communicate with an external apparatus in accordance with the above-described predetermined communication protocol.

A device information management module 324 is a control program that acquires (Get-Request) a MIB as device information and updates (Set-Request) a corresponding MIB to set the wireless communication mode with respect to the printing apparatus 100. After the end of the network setup, the device information management module 324 attempts to acquire device information by broadcasting, and performs processing of determining, based on the presence/absence of a response from the printing apparatus 100 via the network, whether the network setup has succeeded.

An NW setup control module 325 is control program that performs connection to the printing apparatus 100 operating in the network setup mode, and performs a network setup of the printing apparatus 100, and corresponds to the above-described setting application. A detailed control procedure will be described later with reference to a flowchart shown in FIGS. 7A and 7B.

The wireless connection control module 326 controls a series of wireless connection processes of a wireless authentication procedure using an encryption method, such as a search for a wireless beacon generated by the master station (AP 102 or printing apparatus 100), an association procedure with the master station, and Wi-Fi Protected Access (WPA). The terminal apparatus 101 according to this embodiment performs only control to operate as a slave station.

The terminal apparatus 101 includes an Operating System (OS) (not shown) in addition to the above-described control programs (modules). The OS of the terminal apparatus 101 as a portable terminal is, for example, Android® but is not limited to this.

The arrangement of the operation unit 210 of the printing apparatus 100 will be described with reference to FIGS. 4A and 4B.

FIG. 4A is a view showing an example of the outer appearance of the operation unit 210 of the printing apparatus 100a. Referring to FIG. 4A, a display unit 401 is a display unit corresponding to the display 211 shown in FIG. 2, and has the function of a touch panel that accepts an operation instruction from the user on the displayed operation menu. A power button 403 corresponds to the power button 213 shown in FIG. 2, and a WC button 410 corresponds to the wireless connection button (WC button) 212 shown in FIG. 2. In this example, if it is determined that initial installation at the time of arrival is in progress or if the UI control module 301 detects the pressing of the WC button 410, the NW setup control module 308 of this embodiment starts the network setup mode. Assume that the WC button 410 is not a software button displayed on the display unit of the printing apparatus but a physical button that is a physical component different from the display unit of the printing apparatus.

An LED 402 is a power LED that is turned on in a state in which the power button 403 is pressed to activate the control programs of the printing apparatus 100. An LED 409 is a status LED that is turned on or flickers in a predetermined display color or is turned off in accordance with an operator call generation status such as a paper jam. Buttons 404, 405, 406, 407, and 408 correspond to the operation button group 214 shown in FIG. 2. In this embodiment, the HOME button 404 used to transition to the top screen of the operation menu and the return button 405 used to return to the layer immediately above the current layer of the operation menu are arranged on the left side of the display unit 401. The cancel button 406 used to interrupt a print job, the color copy button 407 used to start full-color copying, and the monochrome copy button 408 used to start monochrome copying are arranged on the right side of the display unit 401.

FIG. 4B is a view showing an example of the outer appearance of the operation unit 210 of the printing apparatus 100b. The printing apparatus 100b is different from the printing apparatus 100a in that no physical WC button 410 is provided. In the printing apparatus 100b, an item for starting the network setup mode is prepared as one operation menu displayed on the display unit 401. That is, the printing apparatus 100b can display a software button having the same function as that of the WC button 410. Therefore, if the network setup mode ends when performing initial installation at the time of arrival, the printing apparatus 100b cannot restart the network setup mode before the end of the initial installation. Note that to emphasize a characteristic difference, the components other than the WC button 410 are completely the same as those of the printing apparatus 100a. However, the present invention is not limited to this. For example, no copy button may be provided or the display region of the display may be different.

Details of initial installation performed by the printing apparatus 100 at the time of arrival will be described next with reference to flowcharts shown in FIGS. 5 and 6. Processes shown in the flowcharts of FIGS. 5 and 6 are implemented when, for example, the CPU 201 loads the control programs stored in the ROM 203 and executes them. In this embodiment, assume that the overall procedure of the processing shown in the flowchart of FIG. 5 is processed when the initial installation control module 309 shown in FIG. 3 is mainly executed as the control program and other control programs are called and executed by the CPU 201, as needed.

First, when the power button 213 of the operation unit 210 is pressed by a user operation and power supply to the controller 200 is detected, the printing apparatus 100 performs, as processing at the time of power-on, initialization and activation processing of each control program of the printing apparatus 100 shown in FIG. 3 (step S501).

Upon detecting power-on, the controller 200 of the printing apparatus 100 causes the CPU 201 to load the control program called a BIOS stored in the ROM 203 and execute it. The BIOS performs self-check of the memory and the like, and then activates the boot loader stored in the predetermined area in the ROM 203, and the boot loader activates the OS stored in the ROM 203. The OS sequentially starts, as a predetermined boot sequence, processes as the processing units of the respective control programs, thereby activating the initial installation control module 309 and the NW setup control module 308.

The initial installation control module 309 determines whether the power-on is at the time of arrival, with reference to information that indicates whether the power-on is at the time of arrival and is stored in the ROM 203 (step S502). More specifically, if the printing apparatus 100 is activated at the time of arrival, an arrival state flag stored in the ROM 203 is ON. In other words, the case where the power-on is at the time of arrival corresponds to a case where the initial installation processing has not been completed before in the printing apparatus 100. On the other hand, in the second or subsequent activation processing of the printing apparatus 100, the arrival state flag in the ROM 203 is OFF, as will be described later. More specifically, the initial installation control module 309 calls the storage module 302, and requests to read out the arrival state flag in the ROM 203, thereby implementing the determination processing in step S502. If it is determined in step S502 that the power-on is not power-on at the time of arrival, the initial installation control module 309 ends the processing shown in FIG. 5, and performs normal activation processing. In other words, the case where the power-on is not power-on at the time of arrival corresponds to a case where the initial installation processing has been completed in the printing apparatus 100. As the normal activation processing, for example, initialization of another control program such as the scan control module 306 or the like is executed. Note that in the normal activation processing, initial installation processing such as registration adjustment is not executed.

On the other hand, if it is determined in step S502 that the power-on is at the time of arrival, the initial installation control module 309 executes initial installation processing (arrival processing) necessary to enable the printing apparatus 100 to use (step S503). Then, after the end of the arrival processing, the initial installation control module 309 clears the arrival state flag saved in the ROM 203 (step S504), and ends the arrival processing shown in FIG. 5. Since the arrival state flag is set to OFF by the processing in step S504, the arrival processing of step S503 is not executed in the second or subsequent activation processing of the printing apparatus 100.

Next, the detailed procedure of the arrival processing performed in step S503 will be described with reference to the flowcharts shown in FIGS. 6 and 7. In this embodiment, assume that the overall procedure of the processing shown in the flowchart of FIG. 6 is processed when the initial installation control module 309 shown in FIG. 3 is mainly executed as the control program and other control programs are called and executed by the CPU 201, as needed. Assume also that the overall procedure of the processing shown in the flowchart of FIGS. 7A and 7B is processed when the NW setup control module 308 shown in FIG. 3 is mainly executed as the control program and other control programs are called and executed by the CPU 201, as needed.

The initial installation processing (FIG. 6) executed by the initial installation control module 309 and the network setup processing (FIGS. 7A and 7B) executed by the NW setup control module 308 are simultaneously executed as different processes or tasks. While the initial installation processing such as head cleaning is executed, there is a period of time during which the CPU 201 has enough operating time. Using this period of time, the network setup processing (to be described later) is time-divisionally executed along with the initial installation processing. The processes need not be progressed in synchronism with each other between the flowcharts shown in FIGS. 6 and 7.

Referring to FIG. 6, the initial installation control module 309 calls the UI control module 301 to display, on the display 211 of the operation unit 210, a screen for prompting the user to attach the printhead (step S601). Then, the initial installation control module 309 determines whether the printhead has been attached by a user operation (step S602). At this time, for example, the attachment state of the printhead is determined based on sensor information acquired by the print processing module 305 from the printer engine 220. The processes in steps S601 and S602 are repeated until it is determined that the printhead has been attached.

If it is determined that the printhead has been attached, the initial installation control module 309 calls the UI control module 301, and displays, on the display 211, a screen for prompting the user to attach ink tanks (step S603). The initial installation control module 309 determines whether the ink tanks have been attached (step S604). At this time, for example, the attachment states of the ink tanks are determined based on sensor information acquired by the print processing module 305 from the printer engine 220. The processes in steps S603 and S604 are repeated until the ink tanks of all the colors have been attached.

If it is determined that the ink tanks of all the colors have been attached, the initial installation control module 309 displays, on the display 211, a screen for prompting the user to set a sheet (print medium) for printing a registration adjustment pattern (step S605). Then, the initial installation control module 309 determines whether the sheet has been set (step S606). In this embodiment, when the user presses the software button for confirmation on the screen displayed on the display 211, the UI control module 301 determines that the sheet has been set. However, instead of prompting the user to input, for example, the presence/absence of the sheet may be detected using the sensor information. The processes in steps S605 and S606 are repeated until it is determined that the sheet has been set.

If it is determined that the sheet has been set, the initial installation control module 309 calls the print processing module 305 to execute head cleaning (step S607). For example, the print processing module 305 issues an instruction to fill the printhead with ink to the printer engine 220 via the printer I/F 205. Then, upon receiving the instruction, the printer engine 220 executes head cleaning to be able to execute printing. The initial installation control module 309 determines, based on notification information from the print processing module 305, whether the head cleaning has ended (step S608). The process in step S608 is repeated until it is determined that the head cleaning has ended.

If it is determined that the head cleaning has ended, the initial installation control module 309 executes registration adjustment (step S609). The registration adjustment is processing of adjusting the position, height, inclination of the printhead for discharging ink, and adjusting the timing of discharging ink from the printhead. More specifically, in the registration adjustment, the printing apparatus 100 first draws a sheet from a paper feed cassette of the printing apparatus 100, and executes test printing (printing of a test pattern) using a predetermined print pattern. The test pattern is also called a registration adjustment pattern. In the registration adjustment, the printing apparatus 100 accepts a user input indicating the result of the test printing obtained by visual confirmation by the user, and executes adjustment processing as processing of optimizing the ink discharge timing and the position, height, and inclination of the printhead based on the accepted input. Note that the printing apparatus 100 may optically read the result of the test printing by the scanner engine 221, and execute the adjustment processing based on the read result.

The initial installation control module 309 determines whether the registration adjustment has ended (step S610). The process in step S610 is repeated until it is determined that the registration adjustment has ended. If it is determined that the registration adjustment has ended, the initial installation control module 309 ends the arrival processing shown in FIG. 6, and advances the process to step S504 of FIG. 5. As described above, many processes are necessary in the arrival processing but the CPU 201 is in the standby state until the head cleaning and the registration adjustment end. Therefore, it is possible to execute the network setup simultaneously with the arrival processing.

Details of the network setup mode executed by the printing apparatus 100 at the time of arrival will be described next with reference to the flowchart shown in FIGS. 7A and 7B. Processes shown in the flowchart of FIGS. 7A and 7B are implemented when, for example, the CPU 201 loads the control programs stored in the ROM 203 and executes them. Assume that the overall procedure of the processing shown in the flowchart is mainly controlled by the NW setup control module 308 shown in FIG. 3, and is processed when other control programs are called and executed by the CPU 201, as needed. Note that the flowcharts of FIGS. 7A and 7B are always executed at the time of arrival in this embodiment. However, the processing shown in FIGS. 7A and 7B may be started based on a condition such as a timing after the user initializes the network setting of the printing apparatus 100 or the pressing of the WC button 410 with respect to the network setup mode at a time other than the time of arrival.

Only a case where a communication interface as a network setting target is limited to the wireless LAN in the printing apparatus 100 of this embodiment for the sake of descriptive convenience and the printing apparatus 100 is connected to the AP 102 will be described. However, the communication interface as a network setting target may be selected by the user from a wired LAN and direct connection.

The printing apparatus 100 has the network setup mode in which the printing apparatus 100 serves as an AP to wait for a network setup instruction via direct connection. In this embodiment, in addition to this, if attachment of a USB cable is detected, the printing apparatus 100 also waits for an instruction via the USB. Therefore, the NW setup control module 308 calls the communication control module 303 to confirm the presence/absence of connection of the USB cable (step S701). Then, the NW setup control module 308 determines whether the connection of the USB cable has been detected (step S702).

If it is determined that the connection of the USB cable has been detected, the process advances to step S710 to wait for a setup instruction via the USB. Note that the network setup using the USB cable assumes a case where a PC or the like including a USB port serves as the terminal apparatus 101. On the other hand, if it is determined that the connection of the USB cable has not been detected, the process advances to step S703 to activate the network setup mode.

The NW setup control module 308 acquires the arrangement information of the operation unit 210, and confirms the presence/absence of the WC button 212 (step S703). The arrangement information of the operation unit 210 may be stored in advance as model dependent information in the ROM 203 and read out by the storage module 302 or may be returned when the UI control module 301 detects the hardware arrangement of the operation unit 210. Then, the NW setup control module 308 calls the device information management module 307 to store, in the RAM 202, a MIB value indicating information based on the presence/absence of the WC button 212.

Subsequently, the NW setup control module 308 calls the wireless connection control module 310 to activate the network setup AP (master station) (step S704). As described above, the SSID of the setup AP includes a predetermined character string recognizable by the setting application of the terminal apparatus 101, and the terminal apparatus 101 can search for a wireless beacon generated by the wireless unit 207 to perform connection. A password used in connection to the setup AP is assumed to be a fixed password that is grasped in advance by the setting application.

The NW setup control module 308 determines whether the activation of the network setup AP has succeeded (step S705). If it is determined that the activation of the network setup AP has succeeded, the NW setup control module 308 sets a predetermined value (for example, 30 min) in a timer counter (step S706). This is done to end the network setup mode by detecting a time-out after the predetermined time elapses. Assume here that the timer counter is provided by the OS of the printing apparatus 100. Furthermore, the NW setup control module 308 resets (initializes), to 0, a flag for determining whether a network setting change request has been issued. The processing of determining whether a network setting change request has been issued will be described later.

On the other hand, if it is determined that the activation of the network setup AP has failed due to a failure of hardware or the like, the NW setup control module 308 displays information indicating the occurrence of an error on the display 211 (step S726), and ends the processing shown in FIGS. 7A and 7B.

Upon activating the network setup AP, the wireless connection control module 310 waits for an AP connection request from the terminal apparatus 101 while generating a wireless beacon (step S707). The wireless connection control module 310 determines whether the timer counter has become 0 and a time-out has occurred (step S708). If it is determined that a time-out has occurred, the process advances to step S723, and the wireless connection control module 310 ends the network setup AP. In this case, the flag initialized in step S706 remains reset, and it is determined in step S724 that the network setting remains unchanged, thereby ending the processing shown in FIGS. 7A and 7B. If it is determined that a time-out has not occurred, the process advances to step S709.

The wireless connection control module 310 determines whether connection of the terminal apparatus 101 to the network setup AP has been detected (step S709). If it is determined that connection of the terminal apparatus 101 to the network setup AP has not been detected, processes from step S707 are repeated.

If it is determined that connection of the terminal apparatus 101 to the network setup AP has been detected, the NW setup control module 308 calls the communication control module 303 to wait for a network setting change request from the terminal apparatus 101 (steps S710, S711, and S712). In step S711, the communication control module 303 determines whether the condition that the connection is wireless connection and a time-out has occurred is satisfied. If it is determined that the condition is satisfied, the process advances to step S723. In this case as well, the flag initialized in step S706 remains reset, and it is determined in step S724 that the network setting remains unchanged, thereby ending the processing shown in FIGS. 7A and 7B. If it is determined that the condition is not satisfied, the process advances to step S712.

The communication control module 303 determines whether reception data has been detected (step S712). If it is determined that reception data has been detected, the communication control module 303 calls the command analysis module 304 to analyze the data (step S713). If it is determined that no reception data has been detected, the processes from step S710 are repeated.

The command analysis module 304 determines, as a result of analyzing the reception data, whether the data is a device arrangement information acquisition request by SNMP (step S714). More specifically, if the reception data is a Get-Request command defined in SNMP, it is determined that the data is a device arrangement information acquisition request by SNMP. If it is determined that the data is a device arrangement information acquisition request by SNMP, the process advances to step S715, and the command analysis module 304 calls the device information management module 307.

The command analysis module 304 analyzes the device arrangement information acquisition request by SNMP (step S715), and determines whether the request is a request to acquire the arrangement information of the operation unit 210 (step S716). If it is determined that the request is a request to acquire the arrangement information of the operation unit 210, the device information management module 307 generates a corresponding MIB and returns it (step S717). This response is transmitted to the terminal apparatus 101 as a request source by a Get-Response command defined in SNMP. In this embodiment, if the arrangement information of the operation unit 210 is information indicating that the separate WC button 212 is provided, this indicates that it is possible to restart the network setup mode during the arrival processing.

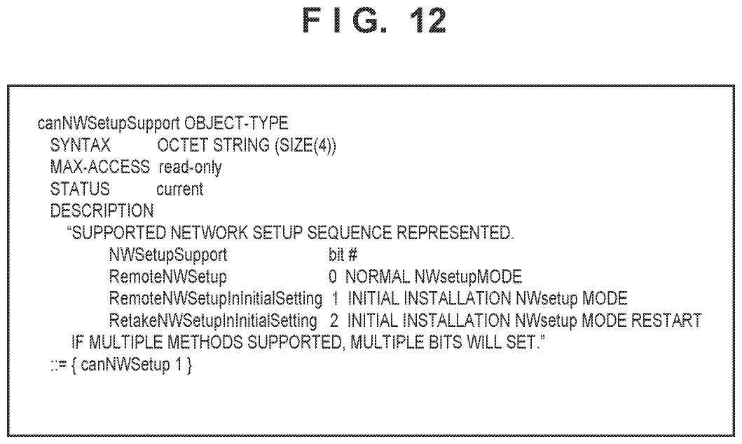

FIG. 12 is a view showing an example of a MIB definition reflecting the arrangement information of the operation unit 210. As a general MIB definition form, a description according to ASN. 1 is shown. Referring to FIG. 12, an Object IDentifier (OID) for identifying the MIB is defined as, for example, canNWSetupSupport, has a size of 4 octets, and is added with a read-only attribute for permitting only read. Note that the OID described in this embodiment is prepared as a private MIB that can freely be defined by each vendor and is described as canNWSetup in a tree structure forming the MIB. If 1 is set in bit 0 (RemotNWSetup) of the data, this indicates that the network setup mode via wireless connection is supported. If 1 is set in bit 1 (RemoteNWSetupInInitialSetting) of the data, this indicates that it is possible to activate the network setup mode during initial installation. Furthermore, if 1 is set in bit 2 (RetakeNWSetupInInitialSetting) of the data, this indicates that it is possible to reactivate the network setup mode during initial installation. The OID will also be referred to as network setup support information hereinafter.

Referring back to step S716 of FIGS. 7A and 7B, if the command analysis module 304 determines that the reception data is not a request to acquire the arrangement information of the operation unit 210, the command analysis module 304 calls the device information management module 307 to respond to a request to acquire other device information, and returns a MIB corresponding to the request (step S718). Assume that the MIB corresponding to the request includes, for example, a product name for specifying the printing apparatus 100, a MAC address, and the current network setting information. The MIB corresponding to the request may be prepared as a standard MIB or defined as a private MIB unique to the vendor. After steps S717 and S718, the process returns to step S710 to wait for subsequent reception data after the device information management module 307 outputs the response.

On the other hand, if it is determined in step S714 that the reception data is not a device arrangement information acquisition request, the command analysis module 304 determines whether the reception data is a wireless LAN setting command, that is, a network setting write request by SNMP (step S719). If it is determined that the reception is not a wireless LAN setting command, for example, if it is determined that the reception data is a print job by a protocol other than SNMP, the command analysis module 304 discards the received data as invalid data (step S722). Then, the process returns to step S710 to wait for next data reception. Note that at this time, the command analysis module 304 may return, to the request source, a response to the command.

On the other hand, if it is determined that the reception data is a wireless LAN setting command, the command analysis module 304 analyzes the wireless LAN setting command by SNMP. Then, the command analysis module 304 acquires network setting values necessary for wireless LAN connection, such as the SSID of the connection target AP, the encryption method, and the password included in the wireless LAN setting command (step S720). Note that the network setting values are also called connection parameters or communication parameters. Then, the NW setup control module 308 sets 1 in a flag indicating that a network setting change request has been issued (step S721). If no USB connection is performed, the wireless connection control module 310 ends the setup AP (step S723).

The network setting values acquired from the wireless LAN setting command are saved as the setting values of the device by the storage module 302 in a predetermined area in the ROM 203. The wireless connection control module 310 determines whether the flag indicating that the network setting change request has been issued has been set to 1 (step S724). If it is determined that the flag has been set to 1, the wireless connection control module 310 shifts to the infrastructure connection mode to reflect the change request. Then, using the network setting values, the wireless connection control module 310 attempts to perform connection to the AP corresponding to the network setting values (step S725).

If connection to the AP 102 as a connection target has succeeded, the printing apparatus 100 can wirelessly communicate with the terminal apparatus 101 in the infrastructure connection mode via a network formed by the connected AP 102. Note that communication via the network formed by the connected AP 102 may be executed by, for example, SNMP or a proprietary protocol provided by the vendor of the printing apparatus 100. Note that the factor of a failure of connection to the AP 102 corresponding to the network setting values set by SNMP includes a case where the AP 102 cannot be found due to a deterioration in a radio wave condition and a case where the setting parameters acquired from the terminal apparatus 101 are incorrect. Furthermore, connection also fails in a case where the printing apparatus 100 does not support the encryption method supported by the AP 102 as a connection target.

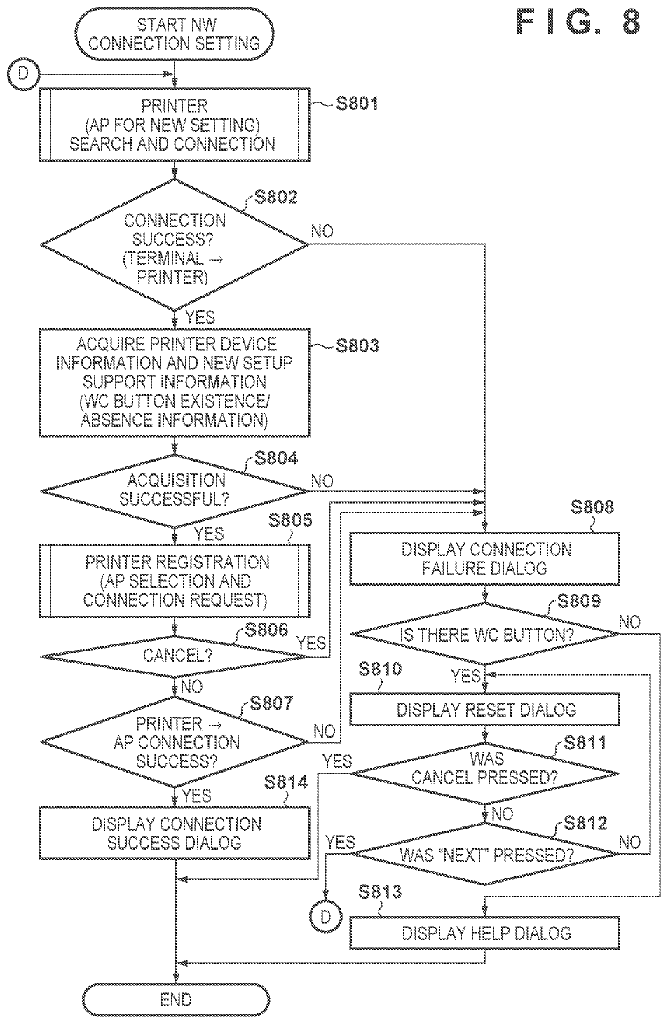

Details of the network setup executed by the terminal apparatus 101 at the time of arrival will be described next with reference to flowcharts shown in FIGS. 8, 9, and 10 and FIGS. 11A to 11F. Processes shown in the flowcharts of FIGS. 8 to 10 are implemented when the CPU 251 loads the control programs (setting application) stored in the ROM 253 and execute them. Assume that the overall procedure of the processing shown in the flowcharts is mainly controlled by the NW setup control module 325 of the terminal apparatus 101 shown in FIG. 3, and is processed when other control programs are called and executed by the CPU 251, as needed.

It is desirable to improve the success rate of the setup by intelligibly notifying the user of a setup procedure of performing transition to a state in which the printing apparatus 100 can wait for connection information to the AP 102 even in a case where the printing apparatus 100 fails to perform connection to the AP 102. For example, the factor of a failure of the setup includes a case where an authentication password as a parameter for connection to the AP 102 is erroneously input or a cancel operation is performed by an erroneous operation on the operation screen of the setting application and a case where a time-out occurs due to an operation interrupt and thus the printing apparatus 100 finishes waiting for connection information.

Especially when a network setup is executed simultaneously with initial installation of the printing apparatus 100, it is difficult to notify the user of the procedure for making it possible to accept a request from the terminal apparatus 101. The operation screen of the printing apparatus 100 during initial installation is used by a necessary operation at the time of arrival such as a sheet setting instruction or registration adjustment. Therefore, it is impossible to notify the user of the procedure of restarting the processing of waiting for connection information.

Not all printing apparatuses have a button (wireless connection button) for a setup, and there are some models that cannot start connection setting unless a setting menu in an operation screen is operated. In the case of the printing apparatus having such arrangement, since the operation menu cannot be displayed while initial installation is performed at the time of arrival, it is impossible to restart a wireless network setup.

In this embodiment, if a network setup during initial installation fails, the terminal apparatus 101 makes a notification suitable to the device arrangement of each printing apparatus. This can improve convenience in a network setup.

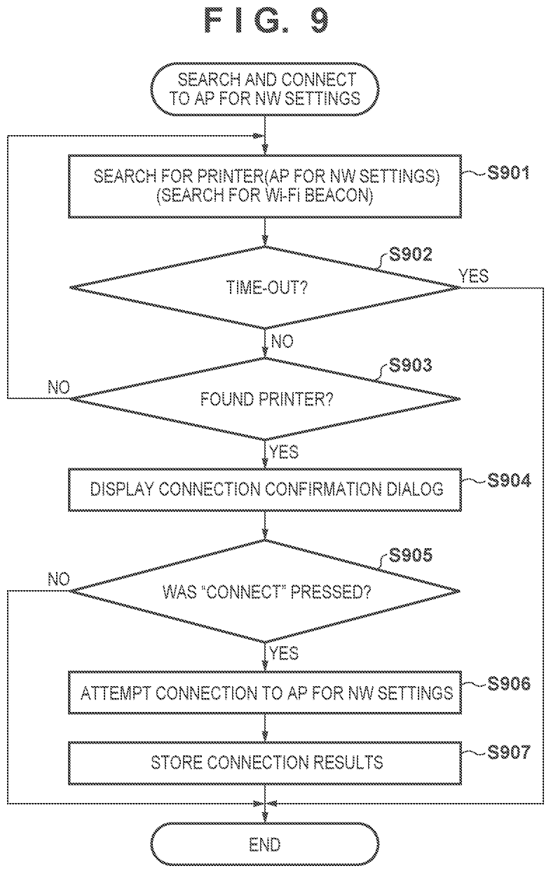

FIG. 8 is a flowchart illustrating the overall processing procedure of a network setup executed by the terminal apparatus 101. In step S801, the setting application searches for the printing apparatus 100 that stands by in the network setup mode. If the printing apparatus 100 that stands by in the network setup mode is found, the setting application performs connection to the setup AP. Details of step S801 will be described with reference to FIG. 9. The processing of the printing apparatus 100 for step S801 corresponds to steps S707 to S709 of FIGS. 7A and 7B.

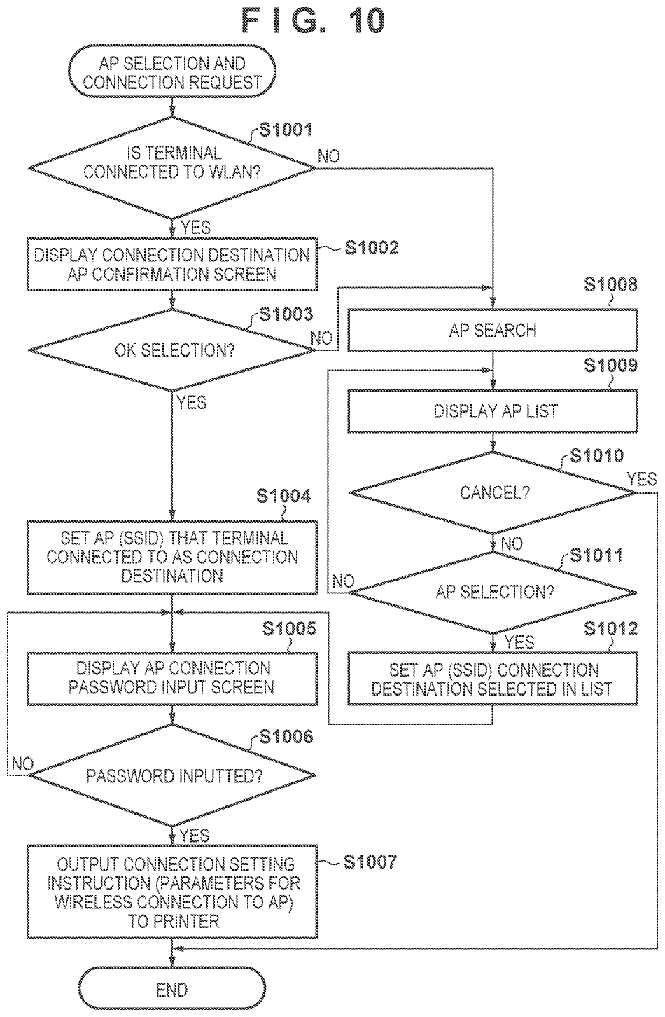

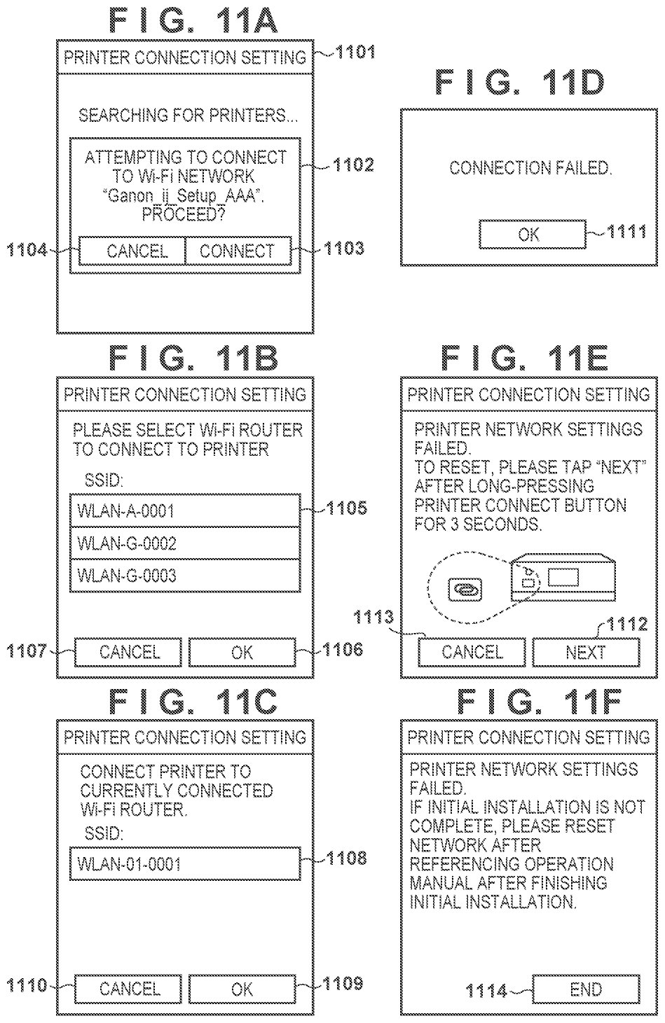

The setting application determines whether connection of the printing apparatus 100 to the setup AP has succeeded (step S802). If it is determined that connection has failed, the setting application displays a dialog screen representing that the network setup has failed (step S808). FIG. 11D is a view showing an example of the dialog screen displayed in step S808. If an OK button 1111 is pressed, the process advances to step S809. In step S809, it is determined, based on network setup support information, whether the printing apparatus 100 has the WC button 410. Note that this determination processing may be processing of determining whether the model number of the printing apparatus 100 is a specific model number. The specific model number is a model number corresponding to the model that has the WC button 410. If it is determined in step S802 that connection has failed, network setup support information has not been acquired. In this case, NO is determined in step S809. In this case, the setting application determines that the printing apparatus is a printing apparatus that cannot restart the network setup mode during arrival processing, and displays a help dialog screen to prompt the user to refer to an operation manual (step S813). FIG. 11F is a view showing an example of the help dialog screen displayed in step S813. Note that in a case where it is possible to view the operation manual in a Web page, a button for displaying the Web page of the operation manual, the URL of the Web page of the operation manual, or the like may be displayed on the help dialog screen. Upon the pressing of a button 1114, the processing shown in FIG. 8 ends. As shown in FIG. 11F, a message for prompting the user to re-execute the network setup after the end of the initial installation is displayed on the help dialog screen.

As described above, according to this embodiment, if it is determined that connection of the printing apparatus 100 to the setup AP has failed, it is possible to prompt the user to re-execute the network setup after the end of the initial installation of the printing apparatus 100. Note that in the above description, the dialog screen is displayed in step S808 and then the determination processing in step S809 is executed. However, the present invention is not limited to this. Step S808 may be omitted and step S809 may be executed. Then, after the determination processing in step S809 is performed, the same contents as those displayed in step S808 may be displayed. That is, the dialog displayed in step S810 or S813 may include the same contents as those displayed in step S808.

On the other hand, if it is determined that connection to the setup AP has succeeded, the setting application calls the device information management module 324 to acquire a MIB by SNMP from the printing apparatus 100 (step S803). That is, the setting application acquires device information of the printing apparatus 100 and network setup support information.

The setting application determines whether the acquisition of the MIB has succeeded (step S804). If it is determined that the acquisition of the MIB has failed, the process advances to step S808. In this case as well, the setting application determines that the printing apparatus is a printing apparatus that cannot restart the network setup mode during arrival processing, and displays the help dialog screen shown in FIG. 11F, thereby ending the processing shown in FIG. 8.

As described above, according to this embodiment, if it is determined that the acquisition of the MIB has failed, it is possible to prompt the user to re-execute the network setup after the end of the initial installation of the printing apparatus 100.

If it is determined that the acquisition of the MIB has succeeded, the setting application decides a connection target AP and transmits a network setting request for connection to the AP to the printing apparatus 100 in order to register the printing apparatus 100 in the setting application (step S805). Details of step S805 will be described later with reference to FIG. 10. The processing of the printing apparatus 100 for step S805 corresponds to steps S710 to S725 of FIGS. 7A and 7B.

The setting application determines whether a cancel instruction by a user operation has been accepted during the processing in step S805 (step S806). If it is determined that a cancel instruction by a user operation has been accepted during the processing in step S805, the process advances to step S808. Then, the setting application checks the network setup support information acquired in step S803 (step S809). If the network setup support information indicate a printing apparatus that can restart the network setup mode during arrival processing, the setting application displays a dialog screen for prompting the user to press the WC button 410 (step S810). FIG. 11E is a view showing an example of the dialog screen displayed in step S810, and presents a method of restarting the network setup using the WC button 410. Note that on the displayed dialog screen, the outer appearance of the printing apparatus 100 and an image indicating the position of the WC button in the printing apparatus 100 may be displayed, as shown in FIG. 11E.

As described above, according to this embodiment, if it is determined that the printing apparatus 100 is a printing apparatus that can restart the network setup mode during arrival processing, it is possible to present the method of restarting the network setup by pressing the WC button 410.

The setting application determines whether a cancel button 1113 has been pressed on the dialog screen shown in FIG. 11E (step S811). If it is determined that the cancel button 1113 has been pressed, the processing shown in FIG. 8 ends. If it is determined that the cancel button 1113 has not been pressed, the setting application determines whether a “next” button 1112 has been pressed (step S812). If it is determined that the “next” button 1112 has been pressed, the process returns to step S801 to restart the network setup. If it is determined that the “next” button 1112 has not been pressed, the process returns to step S810.

If it is determined in step S806 that a cancel operation by the user has not been accepted, the setting application determines whether the printer registration processing in step S805, that is, connection of the printing apparatus 100 to the AP 102 has succeeded (step S807). More specifically, after the terminal apparatus 101 is connected, as a slave station, to the AP 102, the setting application broadcasts an SNMP packet for acquiring device information onto the network formed by the AP 102, and determines, if a response by SNMP is received from the printing apparatus 100, that the network setup has succeeded. If it is determined that the printer registration processing has succeeded, the setting application displays a dialog (not shown) indicating the success of the connection (step S814), and ends the processing shown in FIG. 8. On the other hand, if it is determined that the printer registration processing has failed, the process advances to step S808. From step S808, display control processing in step S810 or S813 according to the network setup support information is performed.

FIG. 9 is a flowchart illustrating a procedure of performing connection of the printing apparatus 100 to the setup AP in the network setup executed by the terminal apparatus 101.

The wireless connection control module 326 of the setting application starts to search for a wireless beacon including an SSID matching the condition of the setup AP (step S901). At this time, the setting application initializes a timer for detecting a time-out, and initializes, to an unconnected state, a flag used to determine whether connection to the setup AP has succeeded. The flag used to determine whether connection to the setup AP has succeeded is used for the determination processing in step S802 of FIG. 8. The setting application determines whether a predetermined time-out time (for example, 30 sec) has elapsed (step S902).

If it is determined that the time-out time has elapsed, the setting application ends the processing shown in FIG. 9. If it is determined that the time-out time has not elapsed, the setting application determines whether an SSID matching the condition of the setup AP has been found (step S903). If an SSID matching the condition of the setup AP has been found, the setting application displays a dialog screen 1102 on a screen 1101 indicating that a search is in progress, as shown in FIG. 11A (step S904). As shown in FIG. 11A, the dialog screen 1102 is a screen for prompting the user to confirm whether the printing apparatus 100 for which the network setup is to be executed is a desired printing apparatus. The setting application determines whether a “connection” button 1103 shown in FIG. 11A has been pressed (step S905). If it is determined that the “connection” button 1103 has been pressed, the setting application attempts to perform connection to the setup AP (step S906), and updates and stores the flag indicating whether connection has succeeded (step S907).

On the other hand, if it is determined that the “connection” button 1103 has not been pressed, this means that a “cancel” button 1104 has been pressed, and thus the processing shown in FIG. 9 ends without updating the flag indicating whether connection to the setup AP has succeeded. In step S802 of FIG. 8, the determination processing is performed based on the flag indicating whether connection to the setup AP has succeeded.

FIG. 10 is a flowchart illustrating a procedure of requesting the printing apparatus 100 to perform network setting in the network setup executed by the terminal apparatus 101.

The setting application determines whether the terminal apparatus 101 has been connected, in the infrastructure connection mode, to a wireless LAN created by the AP (step S1001). This processing is performed when the setting application acquires the network configuration information of the OS using the API provided by the OS of the terminal apparatus 101. If it is determined that the terminal apparatus 101 has been connected to the wireless LAN, the setting application displays a dialog screen shown in FIG. 11C, and prompts the user to confirm whether the connection target AP is a desired AP (step S1002). The setting application determines which of an OK button 1109 and a cancel button 1110 has been pressed by the user by determining the connection target AP based on the SSID displayed in a display region 1108 of the dialog screen (S1003). On the other hand, if it is determined in step S1001 that the terminal apparatus 101 has not been connected to the wireless LAN, the process advances to step S1008.

If it is determined that the “OK” button 1109 has been pressed, the setting application uses, as a network setting parameter for the printing apparatus 100, a setting value concerning the AP to which the terminal apparatus 101 has been connected (step S1004). Furthermore, in this embodiment, the setting application of the terminal apparatus 101 cannot acquire an authentication password concerning the connected AP 102 from the OS, and thus displays a dialog screen (not shown) for prompting the user to input a password for AP connection (step S1005). The setting application stands by until the input of the password is completed (step S1006), and outputs a network setting request described in SNMP to the printing apparatus 100 (step S1007) after detecting the password input.

On the other hand, if it is determined in step S1003 that the “cancel” button 1110 has been pressed, the setting application detects APs that can be connection targets, by searching for a wireless beacon using a plurality of channels (step S1008). Detection of APs indicates detection of networks formed by the APs. Then, the setting application displays a list 1105 of APs detected within a predetermined time, as shown in FIG. 11B, and accepts user selection (step S1009). Note that the list of the found APs indicates a list of the found networks. Note that in a case where no AP can be detected or a case where no AP is selected in the list 1105, an “OK” button 1106 shown in FIG. 11B is displayed not to be pressed, and only a “cancel” button 1107 is displayed to be selectable. If the setting application detects the pressing of the “cancel” button 1107 (YES in step S1010), the setting application ends the processing shown in FIG. 10, and returns to the flowchart shown in FIG. 8. On the other hand, if the setting application detects user selection and the pressing of the “OK” button 1106 (YES in step S1011), the setting application uses, as a network setting parameter for the printing apparatus 100, a setting value concerning the AP selected on the screen shown in FIG. 11B (step S1012). After step S1012, the process advances to step S1005.

The setting application of the terminal apparatus 101 executes the network setup of the printing apparatus 100 by, for example, the above-described procedure. Examples of the factor of a failure of the network setup of the printing apparatus 100 include a case where the user erroneously inputs an authentication password necessary for connection to the AP on the operation screen of the setting application and a case where the user erroneously selects the cancel button on the operation screen. Furthermore, there is a case where the operation of the setting application is interrupted, a time-out occurs in the printing apparatus 100, and thus the printing apparatus 100 finishes waiting for the network setup mode. In this embodiment, even if the network setup fails due to the above factors, it is possible to display, on the setting application, a guidance according to the arrangement of the target printing apparatus, that is, the presence/absence of the WC button 410. Therefore, it is possible to improve convenience in a setup for connecting the printing apparatus 100 to the AP 102.

### Second Embodiment

The second embodiment will be described below concerning points different from the first embodiment. The first embodiment has explained the arrangement in which in a case where connection setting fails or a cancel operation is performed in the setting application in the network setup processing of the printing apparatus 100, a guidance according to the arrangement of the printing apparatus 100, that is, the presence/absence of the WC button 410 is displayed.

In this embodiment, for example, a setting application displays information based on network setup support information acquired from a printing apparatus 100 at a timing earlier than a timing of outputting a network setting request to the printing apparatus 100. With this arrangement, it is possible to notify, not at the time of a connection failure but in advance, the user of a method of coping with a case where connection setting fails.

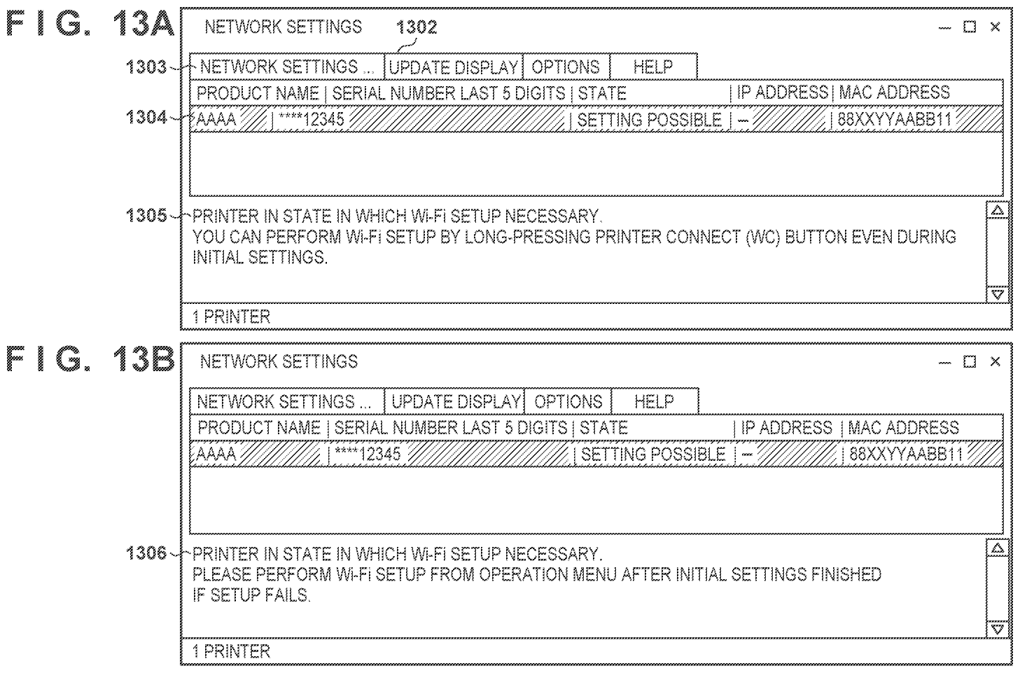

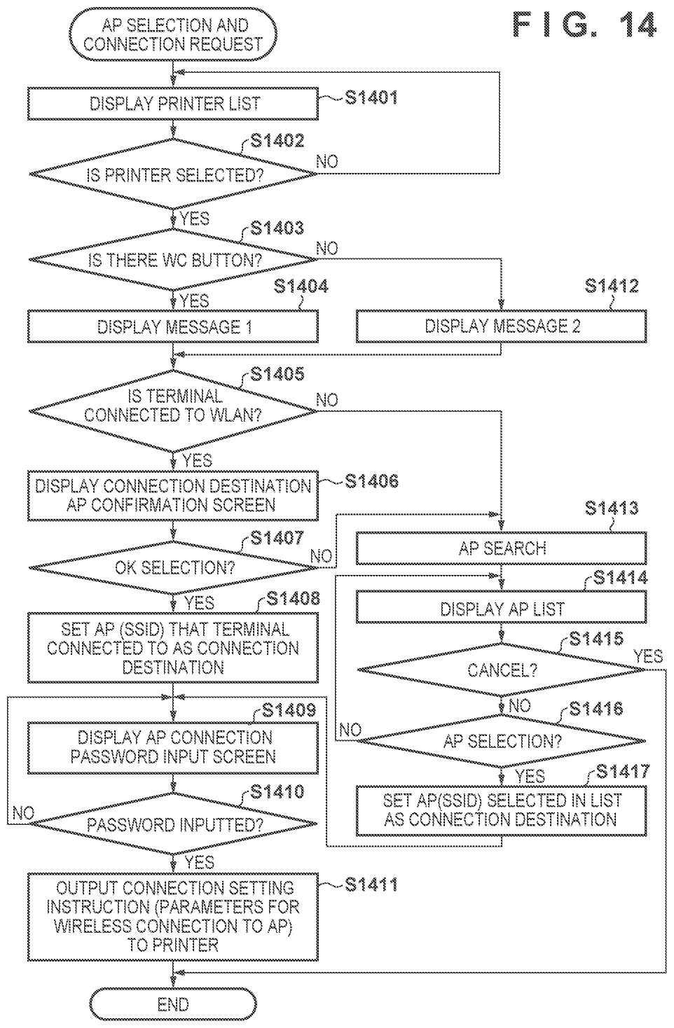

FIGS. 13A and 13B are views each showing an example of the screen configuration of the setting application according to this embodiment. The setting application is provided as, for example, a desktop application that is installed in a PC to operate, and displays, when the printing apparatus 100 in the network setup mode is found, information concerning the found printing apparatus 100 in a list 1304. The setting application according to this embodiment displays, for example, a product name, a serial number, the current status, a MAC address, and the like based on the device information of the printing apparatus 100 acquired by SNMP from the printing apparatus 100. Then, if a printing apparatus in the list 1304 is selected by a user operation, the setting application displays information concerning the selected printing apparatus in a display region 1305 in a lower portion of the screen.

FIG. 13A shows an example of a screen in a case where the network setup support information indicates that the printing apparatus 100 can reactivate the network setup mode during initial installation. Since the printing apparatus 100 has a WC button 212, information indicating that it is possible to restart a network setup even during initial installation is displayed.

On the other hand, FIG. 13B shows an example of a screen in a case where the network setup support information indicates that a printing apparatus 100b cannot reactivate the network setup mode during initial installation. Since the printing apparatus 100b has no WC button 212, information indicating that it is impossible to restart a network setup during initial installation is displayed.

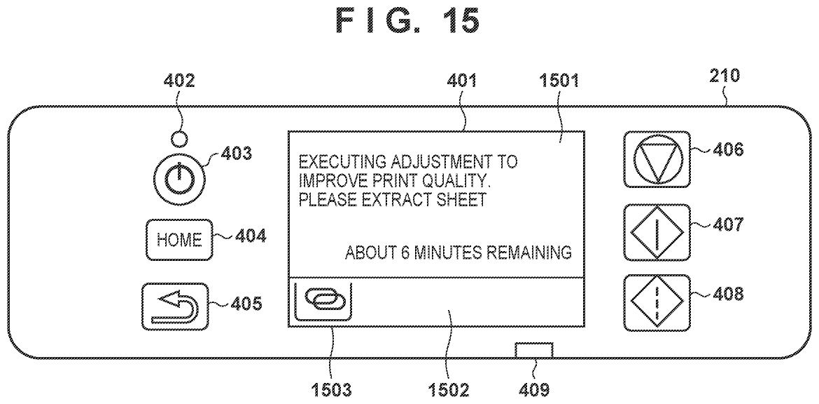

A procedure when the setting application according to this embodiment performs a network setup will be described below with reference to a flowchart shown in FIG. 14. Processes shown in the flowchart of FIG. 14 are implemented when a CPU 251 loads control programs (setting application) stored in a ROM 253 and executes them. The processing shown in FIG. 14 is executed in step S805 of FIG. 8.

The setting application displays, in the list 1304, the connected printing apparatus for a network setup based on the device information of the printing apparatus acquired from the printing apparatus in step S803 of FIG. 8 (step S1401). Note that if the setting application according to this embodiment detects user selection of an operation menu “display refresh” 1302, it searches again for the printing apparatus in the standby state in the network setup mode, and updates contents displayed in the list 1304. At this time, if a plurality of different printing apparatuses are in the standby state in the network setup mode, the setting application displays the plurality of printing apparatuses in the list 1304, and the user can select the printing apparatus as a setup target.

Subsequently, a UI control module 321 of the setting application determines whether one of the printing apparatuses displayed in the list 1304 has been selected (step S1402). If it is determined that one of the printing apparatuses has been selected, the setting application confirms the acquired network setup support information, and determines whether the selected printing apparatus is a printing apparatus having the WC button 212 (step S1403). Note that in this embodiment as well, the network setup support information is information reflecting whether the operation unit 210 of the printing apparatus 100 includes the WC button 212.

If it is determined that the setting target printing apparatus is a printing apparatus having the WC button 212, the setting application displays the message shown in the display region 1305 of FIG. 13A (step S1404). On the other hand, if it is determined that the setting target printing apparatus is a printing apparatus having no WC button 212, the setting application displays a message shown in a display region 1306 of FIG. 13B.

Steps S1405 to S1417 are the same as steps S1001 to S1012 of FIG. 10 and a description thereof will be omitted.

As described above, according to this embodiment, the setting application displays information based on the network setup support information acquired from the printing apparatus 100 at a timing earlier than a timing of outputting a network setting request to the printing apparatus 100. With this arrangement, it is possible to notify, not at the time of a connection failure but in advance, the user of a method of coping with a case where connection setting fails.

### Third Embodiment

The third embodiment will be described below concerning points different from the first and second embodiments. In the communication system described in the first or second embodiment, it is determined whether the network setup can be restarted during initial installation, in accordance with whether the printing apparatus 100 has the physical WC button 212. In this embodiment, for example, a dedicated region where a software button for starting a network setup is displayed is provided in a region of a display unit 401 of a printing apparatus 100b. With this arrangement, the user can restart a network setup even during initial installation of the printing apparatus 100b at the time of arrival.

FIG. 15 is a view showing the outer appearance of an operation unit 210 of the printing apparatus according to this embodiment. In a display region 1501 in the display unit 401, an example of a processing status displayed by a UI control module 301 during initial installation at the time of arrival is shown. For example, FIG. 15 shows a state in which the printing apparatus stands by until registration adjustment ends, and corresponds to the processing of step S609 of FIG. 6.

A display region 1502 in the display unit 401 is a region that is always displayed even at the time of arrival regardless of the processing contents of initial installation. In this embodiment, a software button 1503 for starting a network setup is displayed under the control of the UI control module 301. With this arrangement, the UI control module 301 can recognize the pressing of the software button 1503 by detecting the pressing position on the display unit 401 as a touch panel even during arrival processing. Therefore, the user can reactivate the network setup mode during initial installation. Therefore, network setup support information that can be acquired by a MIB is equivalent to information indicating a printing apparatus having a physical WC button 410. That is, a MIB definition reflecting the arrangement information of the operation unit 210 is the same as the definition shown in FIG. 12. That is, bit 2 (RetakeNWSetupInInitialSetting) of data defined as canNWSetupSupport is set to 1.

As described above, if the software button for starting a network setup is arranged, even if the physical WC button 212 is not arranged, the same guidance as that in a case where the physical WC button 212 is arranged can be displayed on the setting application.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-048615, filed Mar. 24, 2023, which is hereby incorporated by reference herein in its entirety.

What is claimed is:

1. A control method executed by an information processing apparatus, comprising:
acquiring device information of a communication apparatus from the communication apparatus;
executing setup processing for connecting the communication apparatus to an external apparatus outside the communication apparatus and the information processing apparatus; and
displaying, on a display unit, a guidance for executing the setup processing based on the acquired device information of the communication apparatus,
wherein the guidance is made different between a case where the device information of the communication apparatus indicates that the communication apparatus includes a predetermined component and a case where the device information indicates that the communication apparatus does not include the predetermined component.

2. The method according to claim 1, further comprising determining whether the setup processing has succeeded or failed,
wherein in a case where it is determined that the setup processing has failed, the guidance for executing the setup processing is displayed on the display unit based on the acquired device information of the communication apparatus.

3. The method according to claim 2, wherein the determination processing is performed based on an attempt to perform connection to the communication apparatus via the external apparatus.

4. The method according to claim 2, wherein the case where it is determined that the setup processing has failed includes a case where a cancel instruction of the setup processing has been accepted.

5. The method according to claim 1, wherein a first guidance is displayed on the display unit in a case where the device information of the communication apparatus indicates that the communication apparatus includes the predetermined component, and a second guidance is displayed on the display unit in a case where the device information of the communication apparatus indicates that the communication apparatus does not include the predetermined component, and
the first guidance is a guidance for prompting to execute the setup processing using the predetermined component.

6. The method according to claim 1, further comprising executing second setup processing different from the setup processing,
wherein the second setup processing includes at least one of confirmation of attachment of a printhead, confirmation of attachment of an ink tank, processing concerning processing of adjusting a landing position of ink on a sheet in printing, and processing concerning cleaning of the printhead.

7. The method according to claim 1, wherein the predetermined component is a button that can accept an instruction to start, in the communication apparatus, an operation in a mode of executing the setup processing.

8. The method according to claim 7, wherein the button is a hardware button.

9. The method according to claim 7, wherein the button is a software button.

10. The method according to claim 9, wherein the button is displayed in a display portion of the communication apparatus together with information concerning second setup processing including at least one of confirmation of attachment of a printhead, confirmation of attachment of an ink tank, processing concerning processing of adjusting a landing position of ink on a sheet in printing, and processing concerning cleaning of the printhead.

11. The method according to claim 7, wherein the mode of executing the setup processing is a mode in which the communication apparatus operates as an access point.

12. The method according to claim 7, wherein the setup processing includes processing of transmitting information concerning the external apparatus to the communication apparatus via connection between the information processing apparatus and the communication apparatus operating in the mode of executing the setup processing.

13. The method according to claim 7, wherein the guidance displayed in a case where the device information of the communication apparatus indicates that the communication apparatus includes the predetermined component includes a region for prompting a user to operate the button.

14. The method according to claim 6, wherein the second guidance is a guidance for prompting to execute the setup processing after an end of the second setup processing.

15. The method according to claim 1, wherein the device information of the communication apparatus indicating that the communication apparatus includes the predetermined component is acquired from a first communication apparatus that includes the predetermined component and the device information of the communication apparatus indicating that the communication apparatus does not include the predetermined component is acquired from a second communication apparatus that does not include the predetermined component.

16. The method according to claim 1, further comprising searching for a communication apparatus in a state in which it is possible to execute the setup processing,
wherein the device information of the communication apparatus is acquired from the found communication apparatus.

17. The method according to claim 1, wherein
the display unit displays a screen for accepting selection of a communication apparatus for which the setup processing is to be executed, and
the guidance for executing the setup processing is displayed on the screen based on the acquired device information of the communication apparatus.

18. The method according to claim 1, wherein the communication apparatus is a printer.

19. A non-transitory computer-readable storage medium storing a program causing a computer to function to:
acquire device information of a communication apparatus from the communication apparatus;
execute setup processing for connecting the communication apparatus to an external apparatus outside the communication apparatus and the information processing apparatus; and
display, on a display unit, a guidance for executing the setup processing based on the acquired device information of the communication apparatus,
wherein the guidance is made different between a case where the device information of the communication apparatus indicates that the communication apparatus includes a predetermined component and a case where the device information indicates that the communication apparatus does not include the predetermined component.

20. A system comprising a communication apparatus and an information processing apparatus,
the information processing apparatus including at least one memory and at least one processor which function as:
a reception unit configured to request the communication apparatus of device information of the communication apparatus and receive the device information of the communication apparatus;
a setup unit configured to execute setup processing for connecting the communication apparatus to an external apparatus outside the communication apparatus and the information processing apparatus; and
a display control unit configured to display, on a display unit, a guidance for executing the setup processing based on the device information of the communication apparatus received by the reception unit, and
the communication apparatus including at least one memory and at least one processor which function as:
a generation unit configured to generate, in response to the request from the information processing apparatus, the device information of the communication apparatus based on whether the communication apparatus includes a predetermined component; and
a transmission unit configured to transmit, to the information processing apparatus, the device information of the communication apparatus generated by the generation unit,
wherein the display control unit makes the guidance different between a case where the device information of the communication apparatus indicates that the communication apparatus includes the predetermined component and a case where the device information indicates that the communication apparatus does not include the predetermined component.
